(19) United States
(12) Patent Application Publication
(10) Pub. No.: US 2002/0127904 A1
(43) Pub. Date: Sep. 12, 2002

(54) Relay connector

(75) Inventor: Hiroshi Aoki, Shizuoka (JP)

Correspondence Address: SUGHRUE MION, PLLC, 2100 Pennsylvania Avenue, NW, Washington, DC, 20037-3213, US

(73) Assignee: YAZAKI CORPORATION

(21) Appl. No.: 10/083,688

(22) Filed: Feb. 27, 2002

(30) Foreign Application Priority Data
Feb. 28, 2001 (JP) P2001-054858

(51) Int. Cl. H01R 4/24; H01R 4/26; H01R 11/20

(52) U.S. Cl. 439/404

(57) ABSTRACT

A relay connector (11) includes an insulating housing (19), including a housing body (17) and a housing cover (18) covering an upper surface of this housing body, and the plurality of electrical connection terminals (15) which are press-clamped and connected at their rear ends to ends of wires (13), respectively, and are received and held within the insulating housing. Two pairs of piercing portions (15c) for piercing a conductor of a flat circuit member (21) are formed generally upright on a flat surface portion (15b) of a front end portion of the electrical connection terminal (15). A terminal receiving grooves (17a) for respectively receiving the electrical connection terminals are formed in the housing body at intervals corresponding to an arrangement pitch of the conductors (21a) on the flat circuit member (21).

### BACKGROUND OF THE INVENTION

This invention relates to a relay connector for electrically connecting a plurality of wires to a flat circuit member used for controlling equipments, mounted on an automobile or the like and for connecting such equipments together, and more specifically the invention relates to the structure of a relay connector designed to enhance the reliability of the electrical connection and the efficiency of the connecting operation.

In recent years, in the control of various equipments, mounted, for example, on an automobile or the like and in the connection between a plurality of equipments, flat circuit members have increasingly been used as wire harnesses and control circuit boards in order to reduce spaces, occupied by wiring members, circuit boards and the like so as to enhance the installation ability. The term “flat circuit member” means all planar, flexible wiring members including a flexible printed circuit member (hereinafter referred to as “FPC”), comprising a film-like thin, flexible insulating base member on which a wiring circuit is printed, a flexible flat cable (hereinafter referred to as “FFC”), having a plurality of conductors arranged and held at predetermined intervals in a planar condition by a flexible insulating covering member, and a conventional ribbon wire.

With the increased use of such flat circuit members, there have been developed various connecting techniques of electrically connecting the flat circuit member to ends of a plurality of wires positively and easily.

FIG. 7 shows a related relay connector 4 for connecting a flat circuit member 1 to a plurality of wires 2, and this connector is disclosed in Japanese Patent No. 2995966. A flexible insulating base member 1b is removed from an upper surface of the flat circuit member 1 (in the form of an FPC) at an end portion thereof, so that conductors 1a are exposed.

Each wire 2 is an ordinary insulating sheathed wire having a conductor 2a covered with an insulating sheath 2b, and the insulating sheath 2b is stripped from that end portion of the wire, which is to be connected to the exposed conductor 1a, so that the conductor 2a is exposed.

The relay connector 4 comprises a housing body 5, having an upper surface on which the flat circuit member 1 and the plurality of wires 2 are adapted to be placed, and a housing cover 6 covering the upper side of this housing body 5. The housing body 5 includes positioning pins 5a for fitting in the flat circuit member 1, wire clamping claws 5b for fixing the wires 2 in accordance with the arrangement of conductors 1a on the flat circuit member 1, and an elongate projection 5c for forming a bent portion at the flat circuit member 1 placed on the upper surface of this housing body.

The housing cover 6 includes elastic engagement piece portions 6a, which can be engaged respectively with retaining projections 5d, formed on side surfaces of the housing body 5, to combine this housing cover and the housing body 5 together in a unitary manner, wire fitting grooves 6b for positioning the wires 2 placed on the housing body 5, and a recess 6c corresponding to the elongate projection 5c on the housing body 5. This recess 6c presses that portion of the flat circuit member 1, bent by the elongate projection 5c on the housing body 5, against the elongate projection 5c, thereby effecting the prevention of withdrawal (strain relief) of the flat circuit member 1.

An operation for connecting the flat circuit member 1 to the plurality of wires 2 by the relay connector 4 of the above construction is effected, for example, according to the following procedure.

First, ends of the exposed conductors 1a of the flat circuit member are positioned on the housing body 5 by the positioning pins 5a.

Then, the wires 2 are fixed by the wire clamping claws 5b in such a manner that the exposed conductors 2a of the wires 2 are superposed on the conductors 1a of the flat circuit member 1, respectively.

Then, the conductors 2a of the wires 2 are soldered to the conductors 1a of the flat circuit member 1, respectively, and then the housing cover 6 is fitted on the housing body 5, and is engaged with this housing body 5, thus completing the connecting operation.

In the above related relay connector 4, the electrical connection between the flat circuit member 1 and the wires 2 is effected by soldering the conductors of the flat circuit member respectively to the conductors of the wires, and the soldering operation must be effected for each wire, and hence must be carried out repeatedly. Therefore, there have been encountered problems that much time is required for the operation and that the efficiency of the operation is low.

And besides, when each wire 2 is to be fixed by the wire clamping claw 5b, the wire 2 is, in some cases, displaced in the axial direction, and the actual length of the conductor 2a, soldered to the conductor 1a, becomes short. Therefore, there has been encountered a problem that the reliability of the electrical connection is lowered.

In addition, when there is applied a force F to lift or roll up the flat circuit member 1 off the housing body 5, the retained condition of this flat circuit member, achieved by the positioning pins 5a, is canceled since the flat circuit member 1 can be disengaged upwardly from the housing body, and as a result the flat circuit member 1 is moved, which has invited a problem that the incomplete electrical connection develops if such movement occurs before the solidification of the solder.

If the wire 2 is displaced laterally (in a direction of arrow A in the drawing) when fitting the housing cover 6 on the housing body 5, this wire 2 is not fitted in the wire fitting groove 6b in the housing cover 6, and is caught or held between the housing cover 6 and the housing body 5, so that the elastic retaining piece portions 6a on the housing cover can not be engaged with the respective retaining projections 5d. Therefore, when fitting the housing cover 6 on the housing body 5, this operation must be carried out carefully, and therefore there has been encountered a problem that the efficiency of the operation can not be enhanced.

### SUMMARY OF THE INVENTION

It is an object of this invention to solve the above problems, and more specifically to provide a relay connector which can electrically connect a flat circuit member to a plurality of wires positively and easily without the need for soldering, and can enhance the reliability of electrical connection between the flat circuit member and the wires, and can enhance the efficiency of the connecting operation.

In order to solve the aforesaid object, the invention is characterized by having the following arrangement.

(1) A relay connector for connecting wires to a flat circuit member having a plurality of conductors, the relay connector comprising:

a plurality of electrical connection terminals, each including at its rear end portion a wire connection portion to which the wire is connectable, and at its front end portion a pair of piercing portions to pierce the conductor of the flat circuit member; and

a insulating housing for receiving and holding the plurality of electrical connection terminals at a interval corresponding to an arrangement pitch of the plurality of conductors of the flat circuit member,

wherein the pairs of piercing portions are caused to pierce the plurality of conductors at one time and are bent back, respectively.

(2) The relay connector according to (1), wherein the pair of piercing portions is formed at a flat surface portion of the front end portion of the electrical connection terminal and projects substantially upright.

(3) The relay connector according to (1), wherein

the insulating housing includes a housing body having a plurality of terminal receiving grooves in which the plurality of electrical connection terminals are received, respectively, and a housing cover for covering the plurality of terminal receiving grooves.

(4) The relay connector according to (2), wherein

each of the plurality of terminal receiving grooves includes a retaining projection engaged with the electrical connection terminal to position the electrical connection terminal in an axial direction of the electrical connection terminal.

(5) The relay connector according to (4), wherein each of the plurality of the electrical connection terminals includes an engagement portion engaged with the corresponding retaining projection.

(6) The relay connector according to (1), wherein the pairs of piercing portions projects forwardly from the insulating housing when the plurality of electrical connection terminals are received in the insulating housing.

### BRIEF DESCRIPTION OF THE DRAWINGS

FIG. 1 is an exploded, perspective view showing one preferred embodiment of a relay connector of the present invention.

FIG. 2 is a perspective view showing a retaining projection on a housing body of FIG. 1.

FIG. 3 is a perspective view showing the relay connector of FIG. 1 in its assembled condition.

FIG. 4 is a cross-sectional view showing a condition before piercing portions of an electrical connection terminal of FIG. 1 are caused to pierce a conductor of the flat circuit member.

FIG. 5 is a cross-sectional view showing a condition in which the electrical connection terminal of FIG. 1 is press-fastened after the piercing portions of the electrical connection terminals are caused to pierce the conductor of the flat circuit member.

FIG. 6 is a fragmentary perspective view of an important portion, showing a condition in which the flat circuit member is electrically connected to the plurality of electrical connection terminals held by the relay connector of FIG. 1.

FIG. 7 is a exploded perspective view of a related relay connector.

### DETAILED DESCRIPTION OF PREFERRED EMBODIMENTS

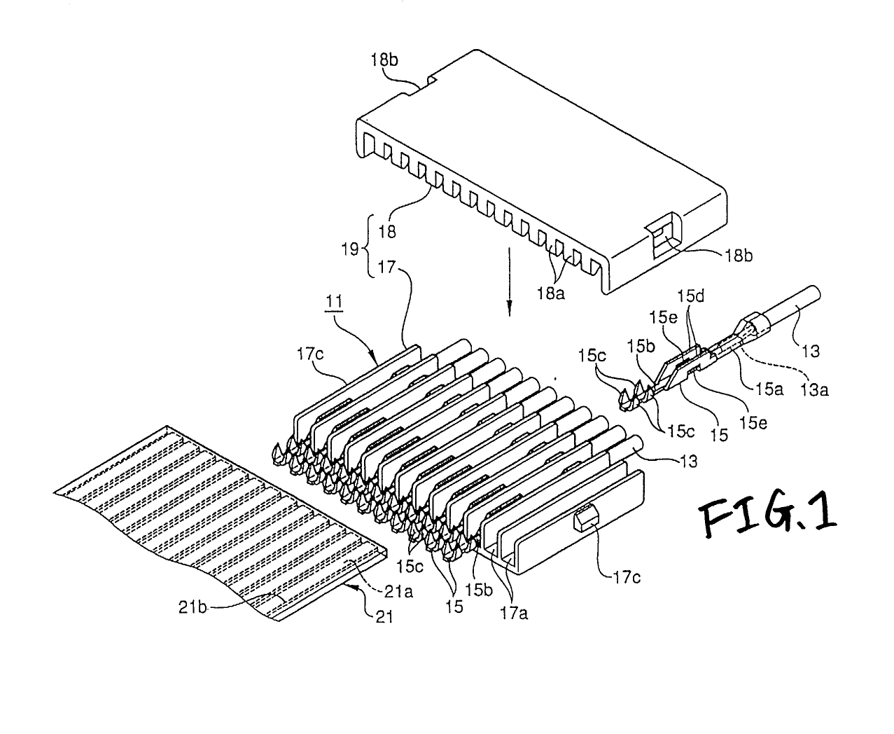

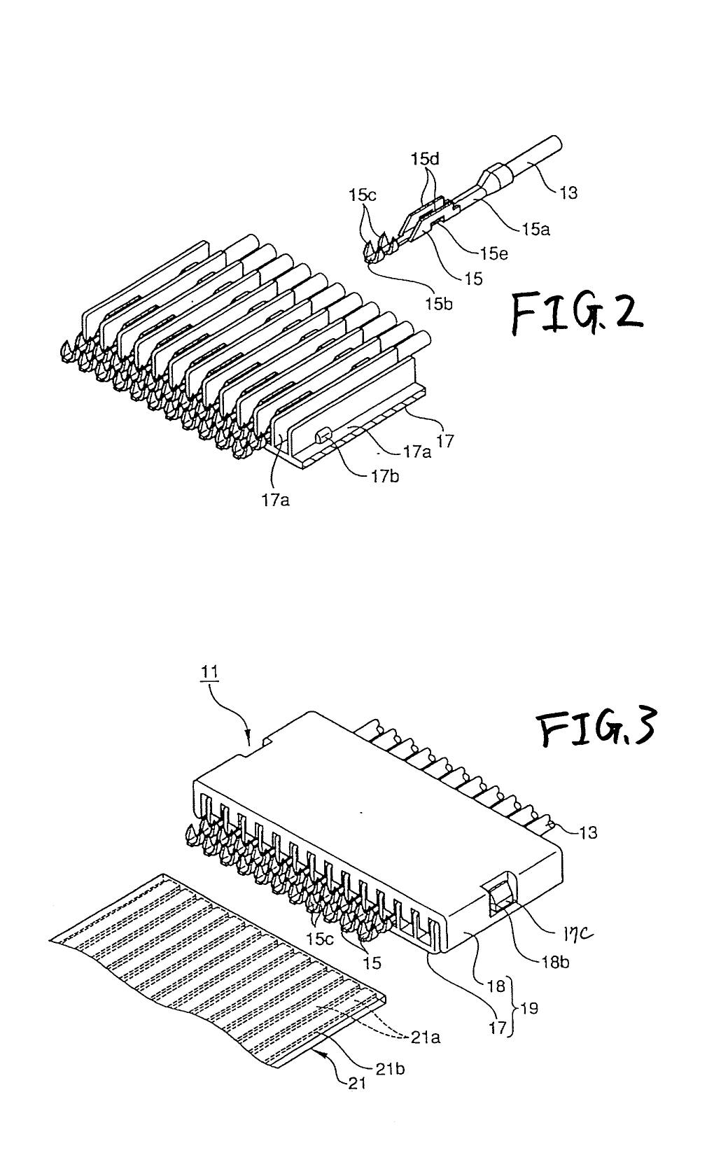

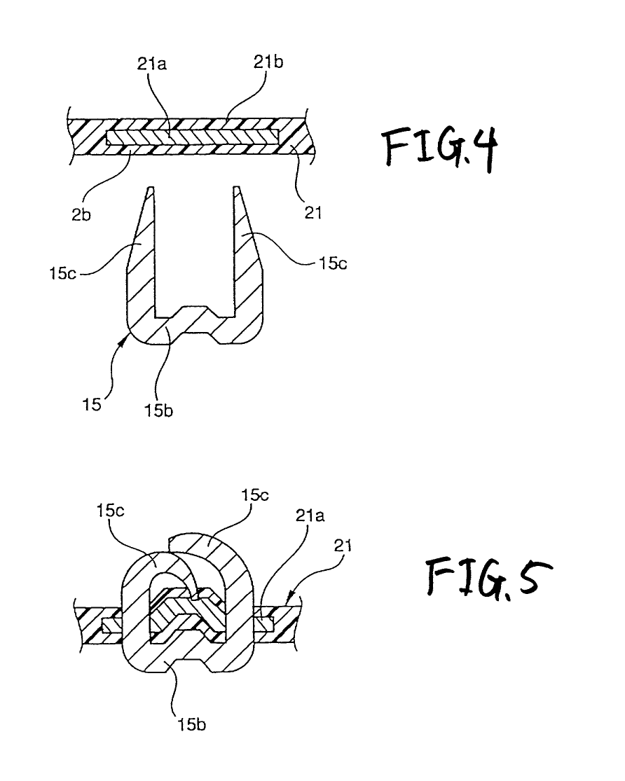

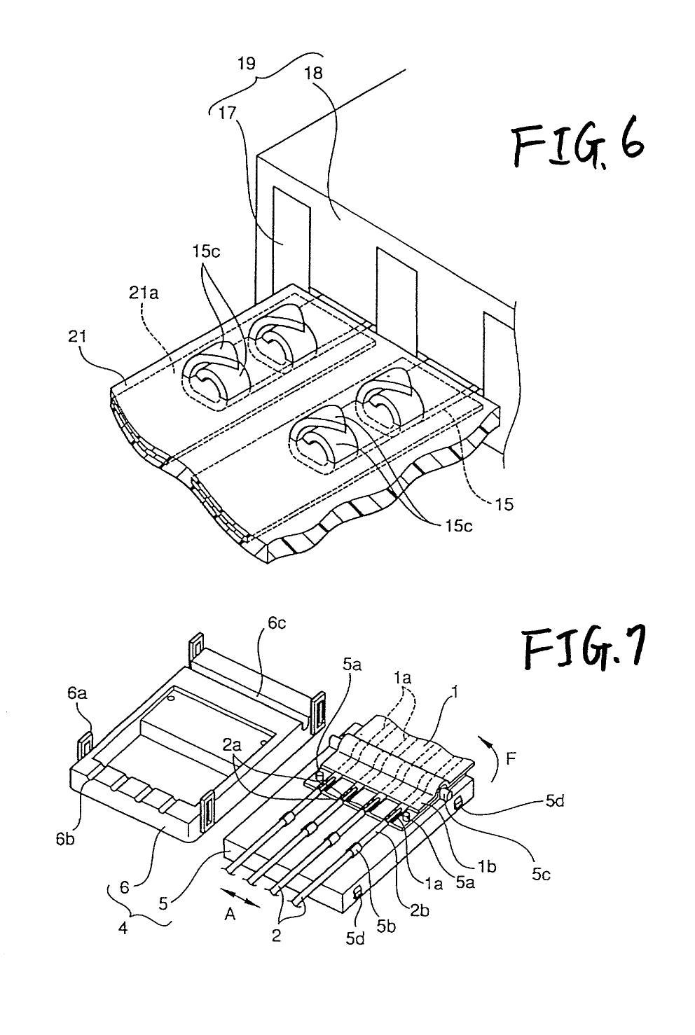

A relay connector according to an embodiment of the present invention will now be described in detail with reference to FIGS. 1 to 6. FIG. 1 is an exploded, perspective view showing the relay connector according to the embodiment of the invention, FIG. 2 is a perspective view showing a retaining projection on a housing body of FIG. 1, FIG. 3 is a perspective view showing the relay connector of FIG. 1 in its assembled condition, FIG. 4 is a cross-sectional view showing a condition before piercing portions of an electrical connection terminal of FIG. 1 are caused to pierce a conductor of the flat circuit member, FIG. 5 is a cross-sectional view showing a condition in which the electrical connection terminal of FIG. 1 is press-fastened after the piercing portions of the electrical connection terminals are caused to pierce the conductor of the flat circuit member, and FIG. 6 is a fragmentary perspective view of an important portion, showing a condition in which the flat circuit member is electrically connected to the plurality of electrical connection terminals held by the relay connector of FIG. 1.

As shown in FIG. 1, the relay connector 1 according to the embodiment comprises: an insulating housing 19 including the housing body 17 and a housing cover 18 covering an upper surface of this housing body 17; and a plurality of electrical connection terminals 15 which are press-clamped and connected at their rear ends to ends of wires 13, respectively, and are received and held side by side within the insulating housing 19.

The electrical connection terminal 15 is a so-called piercing terminal formed by pressing a metal sheet, and includes at its rear end portion a wire clamping portion 15a, to which a wire end portion 13a is press-clamped and connected, and two pairs of piercing portions 15c which are formed generally upright at a flat surface portion 15b of its front end portion so as to pierce the conductor of the flat circuit member 21. Engagement portions 15e, which are used for positioning the electrical connection terminal 15 in the axial direction, are formed, by notching, respectively in opposite side walls 15d disposed between the front end portion and rear end portion of this electrical connection terminal.

The housing body 17 is an integrally-molded product made of an insulating resin. A plurality of terminal receiving grooves 17a for respectively receiving the electrical connection terminals 15 are formed in this housing body, and are arranged at intervals corresponding to an arrangement pitch of the conductors 21a on the flat circuit member 21 (described later).

As shown in FIG. 2, a pair of opposed retaining projections 17b are formed respectively at predetermined portions of opposite side portions of a bottom portion of each terminal receiving groove 17a. When the electrical connection terminal 15 is inserted into the wire receiving groove from the upper side, these retaining projections 17b are engaged respectively in the engagement portions 15e in the electrical connection terminal 15 to thereby position the electrical connection terminal in the axial direction in a state that the front end portion of this electrical connection terminal projects from the housing body 17. Projections 17c, which are used for engaging the housing body 17 with the housing cover 18 (described later), are formed on the outer surface of the housing body 17.

As shown in FIG. 1, the housing cover 18 is an integrally-molded product made of an insulative resin. The terminal holding projections 18a for holding the electrical connection terminals 15, received respectively in the terminal receiving grooves 17a, respectively against the bottoms of the terminal receiving grooves 17a are formed on this housing cover, and are disposed in an arrangement corresponding to that of the terminal receiving grooves 17a. Engagement portions 18bfor engagement respectively with the projections 17c of the housing body 17 are formed respectively in opposite side walls of the housing cover 18. The housing cover is adapted to be fitted on the housing body 17 to cover the upper sides of the plurality of terminal receiving grooves 17a, and engaged with the housing body 17.

The flat circuit member 21 is a flexible FPC as described above, and includes the conductors 21a serving as wiring circuits, and a film-like thin, flexible insulating base member 21b in which the conductors 21a are insert-molded. An FFC, having a plurality of conductors arranged and held at predetermined intervals in a planar manner by a flexible insulating covering member, a ribbon wire or the like can be used.

Next, the procedure of assembling the relay connector of the above construction will be described.

First, as shown in FIGS. 1 and 2, in the relay connector 11, when the electrical connection terminals 15, each press-clamped at its rear end to the end of the wire 13, are inserted respectively into the terminal receiving grooves 17a from the upper side in such a manner that the piercing portions 15c, formed at the distal end portions of these electrical connection terminals 15, project from the front end of the housing body 17, the engagement portions 15e of each electrical connection terminal 15 are engaged respectively with the retaining projections 17b in the corresponding terminal receiving groove 17a in the housing body 17.

Then, the housing cover 18 is attached to the housing body 17 from the upper side as shown in FIG. 3, and the engagement portions 18 are engaged with the projections 17c, respectively, so that the electrical connection terminals 15, received and held in the housing body 17, are firmly fixed by the terminal holding projections 18a, respectively.

Then, as shown in FIGS. 3 to 5, the piercing portions 15c of the plurality of electrical connection terminals 15, projecting side by side from the front end of the insulating housing 19, are caused to pierce the conductors 21a and flexible insulating base member 21b of the flat circuit member 21 at one time. Then, the distal end portions of each pair of piercing portions 15c are bent back in overlapping relation to each other, and are press-fastened. As a result, the conductors 21a of the flat circuit member 21 are electrically and mechanically connected to the piercing portions 15c of the respective electrical connection terminals 15 at one time.

As described above, in the relay connector 11 according to the embodiment, the plurality of electrical connection terminals 15, connected respectively to the wire end portions 13a, are received side by side in the insulating housing 19 in such a manner that the piercing portions 15c of these electrical connection terminals project from the front end of the housing body 17. Therefore, the electrical connection terminals 15 are beforehand positively and easily positioned and fixed at the pitch corresponding to the arrangement pitch of the conductors 21a of the flat circuit member 21.

Then, the plurality of piercing portions 15c, projecting outwardly from the insulating housing 19, are caused to pierce the end portion of the flat circuit member 21 at one time, and are bent back, thus completing the electrical and mechanical connection of the electrical connection terminals 15 to the flat circuit member 21.

Therefore, a soldering operation, which requires much time and labor, is not needed for electrical connection of the wires 13 to the conductors 21a of the flat circuit member 21, and the reliability of electrical connection between the flat circuit member 21 and the wires 13 can be enhanced.

And besides, the plurality of electrical connection terminals 15 are connected at one time to the flat circuit member 21. Therefore, the process of the operation is simplified, and the efficiency of the operation for connecting the flat circuit member 21 to the wires 13 can be greatly enhanced.

In addition, each of the electrical connection terminals 15, mounted in the housing body 17, is prevented by the terminal receiving groove 17a from being moved in a direction perpendicular to its axial direction in a horizontal plane, and also is prevented by the retaining projections 17b in the terminal receiving groove 17a from being moved in its axial direction. Therefore, each electrical connection terminal is accurately positioned in the lateral and axial directions.

Therefore, the housing cover 18 can be easily attached to the housing body 17, and because of the enhanced assembling ability of the relay connector, the efficiency of the operation for connecting the flat circuit member 21 to the wires 13a can be further enhanced.

Furthermore, by attaching the housing cover 18, the electrical connection terminals 15 are prevented from being disengaged from the respective terminal receiving grooves 17a, and are positioned positively and firmly. Therefore, the connecting operation, in which the piercing portions 15 of each electrical connection terminal 15 are caused to pierce the predetermined portions of the flat circuit member 21, can be carried out highly precisely and efficiently without inviting undesirable situations such as variations of piercing positions.

In this embodiment, although the electrical connection terminal 15 has the two pairs of piercing portions 15c formed at the front end portion thereof, the number of the piercing portions is not limited to those of the above embodiment, and for example, only one pair of piercing portions 15c may be provided in so far as the necessary electrical and mechanical connecting characteristics can be sufficiently secured, or three or more pairs may be provided.

As described above, in the relay connector of the invention, the plurality of electrical connection terminals, connected respectively to the wire end portions, are received side by side in the insulating housing, and therefore the end portions of the plurality of wires can be beforehand positioned in an arrangement corresponding to the arrangement of the conductors of the flat circuit member, and the piercing portions of the plurality of electrical connection terminals, projecting outwardly from the insulating housing, are caused to pierce the predetermined portions of the end portion of the flat circuit member at one time, and then are bent back. By doing so, the operation for electrically and mechanically connecting the electrical connection terminals to the flat circuit member can be completed positively and easily.

Therefore, the plurality of electrical connection terminals can be connected to the flat circuit member at one time, and a soldering operation, which requires much time and labor, is not needed for electrical connection of the wires to the conductors of the flat circuit member. Therefore, the time and labor, required for the operation, can be reduced, and the efficiency of the operation for connecting the flat circuit member to the wires can be enhanced, and there can be obtained the relay connector of high reliability.

In the relay connector of the invention, each of the electrical connection terminals, mounted in the housing body, is prevented by the terminal receiving groove from being moved in the lateral direction perpendicular to its axial direction in a horizontal plane, and also is prevented by the retaining projections in the terminal receiving groove from being moved in its axial direction, and therefore each electrical connection terminal can be accurately positioned in the lateral and axial directions.

And besides, since the housing cover is attached, the electrical connection terminals are prevented from being disengaged from the respective terminal receiving grooves, and are positioned accurately and firmly in the terminal receiving grooves, respectively, and in this condition the piercing portions of the electrical connection terminals can be caused to pierce the conductors of the flat circuit member, and therefore variations in the piercing portion-piercing positions will not occur, and the highly-precise, stable connecting operation can be carried out.

Therefore, the housing cover can be easily attached to the housing body, and the operation for connecting the electrical connection terminals to the flat circuit member can be carried out highly precisely. Therefore, the highly-precise connecting operation can be carried out more efficiently.

In the relay connector of the invention, the flat circuit member is moved from a position above the piercing portions of the electrical connection terminals, projecting from the housing body, so that these piercing portions pierce the conductors of the flat circuit member at one time, and then are bent back, thus effecting the connecting operation.

Therefore, in contrast with a connecting operation, effected in the terminal receiving grooves, the connecting operation can be carried out at a region outside the housing body where there is no space limitation. Therefore, the efficiency of the highly-precise connecting operation can be further enhanced.

What is claimed is:

1. A relay connector for connecting wires to a flat circuit member having a plurality of conductors, the relay connector comprising:
a plurality of electrical connection terminals, each including at its rear end portion a wire connection portion to which the wire is connectable, and at its front end portion a pair of piercing portions to pierce the conductor of the flat circuit member; and
a insulating housing for receiving and holding the plurality of electrical connection terminals at a interval corresponding to an arrangement pitch of the plurality of conductors of the flat circuit member,
wherein the pairs of piercing portions are caused to pierce the plurality of conductors at one time and are bent back, respectively.

2. The relay connector according to claim 1, wherein the pair of piercing portions is formed at a flat surface portion of the front end portion of the electrical connection terminal and projects substantially upright.

3. The relay connector according to claim 1, wherein
the insulating housing includes a housing body having a plurality of terminal receiving grooves in which the plurality of electrical connection terminals are received, respectively, and a housing cover for covering the plurality of terminal receiving grooves.

4. The relay connector according to claim 2, wherein
each of the plurality of terminal receiving grooves includes a retaining projection engaged with the electrical connection terminal to position the electrical connection terminal in an axial direction of the electrical connection terminal.

5. The relay connector according to claim 4, wherein each of the plurality of the electrical connection terminals includes an engagement portion engaged with the corresponding retaining projection.

6. The relay connector according to claim 1, wherein the pairs of piercing portions projects forwardly from the insulating housing when the plurality of electrical connection terminals are received in the insulating housing.
